(19) United States
(12) Patent Application Publication
(10) Pub. No.: US 2007/0067386 A1
(43) Pub. Date: Mar. 22, 2007

(54) Embedded media server

(75) Inventors: Arthur MacArthur, Aliso Viejo, CA (US); Scott Lambden, Anaheim, CA (US); Maggie Chen, Irvine, CA (US); Jeff Chen, Irvine, CA (US)

Correspondence Address: BERKELEY LAW & TECHNOLOGY GROUP, 1700NW 167TH PLACE, SUITE 240, BEAVERTON, OR, 97006, US

(73) Assignee: D-Link Systems, Inc.

(21) Appl. No.: 11/216,844

(22) Filed: Aug. 30, 2005

(51) Int. Cl. G06F 3/00; G06F 15/16

(52) U.S. Cl. 709/204; 710/1

(57) ABSTRACT

Disclosed are a system and method of providing a media server in a data communication network. A device may automatically provide a server in response to application of power to a computing platform and/or computing device.

### BACKGROUND

1. Field

The subject matter disclosed herein relates to servers.

2. Information

While the use of personal computer (PC) technology has been traditionally employed in organizations for specific business applications such as word processing, accounting and Internet access, PCs are increasingly being employed as part of home entertainment systems. For example, PCs may be purchased with software bundles including a Windows XP Home Edition operating system and home entertainment software such as Media Center 2005 application software developed by Microsoft, Inc. To employ functions of such home entertainment software, a user typically launches an operating system to a PC platform. Once the operating system is running, a user may select to launch a home entertainment application by, for example, selecting a desktop icon using a graphical user interface.

### BRIEF DESCRIPTION OF THE FIGURES

Non-limiting and non-exhaustive embodiments will be described with reference to the following figures, wherein like reference numerals refer to like parts throughout the various figures unless otherwise specified.

FIG. 1 is a schematic diagram of a network topology according to an embodiment.

FIG. 2 is a schematic diagram of a device capable of hosting a server according to an embodiment.

FIG. 3 is a flow diagram illustrating a process to launch a server in response to application of power to a device according to an embodiment.

### DETAILED DESCRIPTION

Reference throughout this specification to “one embodiment” or “an embodiment” means that a particular feature, structure, or characteristic described in connection with the embodiment is included in at least one embodiment of claimed subject matter. Thus, the appearances of the phrase “in one embodiment” or “an embodiment” in various places throughout this specification are not necessarily all referring to the same embodiment. Furthermore, the particular features, structures, or characteristics may be combined in one or more embodiments.

Some portions of the detailed description which follow may be presented in terms of algorithms and/or symbolic representations of operations on data bits or binary digital signals stored within a computing system memory, such as a computer memory. These algorithmic descriptions and/or representations are the techniques used by those of ordinary skill in the data processing arts to convey the substance of their work to others skilled in the art. An algorithm is here, and generally, considered to be a self-consistent sequence of operations and/or similar processing leading to a desired result. The operations and/or processing involve physical manipulations of physical quantities. Typically, although not necessarily, these quantities may take the form of electrical and/or magnetic signals capable of being stored, transferred, combined, compared and/or otherwise manipulated. It has proven convenient at times, principally for reasons of common usage, to refer to these signals as bits, data, values, elements, symbols, characters, terms, numbers, numerals and/or the like. It should be understood, however, that all of these and similar terms are to be associated with the appropriate physical quantities and are merely convenient labels. Unless specifically stated otherwise, as apparent from the following discussion, it is appreciated that throughout this specification discussions utilizing terms such as “processing”, “computing”, “calculating”, “transforming,” “mapping,” “obtaining, ” “selecting, ” “representing,” “storing,” “associating,” “launching,” “substituting,” “determining” and/or the like refer to the actions and/or processes of a computing platform, such as a computer or a similar electronic computing device, that manipulates and/or transforms data represented as physical electronic and/or magnetic quantities and/or other physical quantities within the computing platform's processors, memories, registers, and/or other information storage, transmission, and/or display devices. Further, unless specifically stated otherwise, processes described herein, with reference to flow diagrams or otherwise, may also be executed and/or controlled, in whole or in part, by such a computing platform.

“Instructions” as referred to herein relate to expressions which represent one or more logical operations. For example, instructions may be “machine-readable” by being interpretable by a machine for executing one or more operations on one or more data objects. However, this is merely an example of instructions and claimed subject matter is not limited in this respect. In another example, instructions as referred to herein may relate to encoded commands which are executable by a processing circuit having a command set which includes the encoded commands. Such an instruction may be encoded in the form of a machine language understood by the processing circuit. Again, these are merely examples of an instruction and claimed subject matter is not limited in this respect.

“Storage medium” as referred to herein relates to media capable of maintaining expressions which are perceivable by one or more machines. For example, a storage medium may comprise one or more storage devices for storing machine-readable instructions and/or information. Such storage devices may comprise any one of several media types including, for example, magnetic, optical or semiconductor storage media. However, these are merely examples of a storage medium and claimed subject matter is not limited in these respects.

“Logic” as referred to herein relates to structure for performing one or more logical operations. For example, logic may comprise circuitry which provides one or more output signals based upon one or more input signals. Such circuitry may comprise a finite state machine which receives a digital input and provides a digital output, or circuitry which provides one or more analog output signals in response to one or more analog input signals. Such circuitry may be provided in an application specific integrated circuit (ASIC) or field programmable gate array (FPGA). Also, logic may comprise machine-readable instructions stored in a storage medium in combination with processing circuitry to execute such machine-readable instructions. However, these are merely examples of structures which may provide logic and claimed subject matter is not limited in this respect.

A “processor” as referred to herein relates to circuitry and/or logic capable of executing processes and/or procedures according to machine-readable instructions. For example, a processor may retrieve machine-readable instructions from a storage medium, execute processes for processing information based at least in part on the retrieved instructions and provide a result based at least in part on the processed data. A processor may be embedded on an integrated circuit to support specific predetermined functionality (e.g., on an application specific integrated circuit (“ASIC”). The circuitry embedded to realize the processor functionality may be synthesized using a high level design language description software. In another embodiment, the processor may be implemented using a general purpose integrated circuit processor and may be included in a common package along with integrated circuit memory devices in accordance with a system-in-package (“SIP”) approach. In particular embodiments, for example, a processor may be characterized as a “controller,” “microcontroller,” “microprocessor” and/or other programmable logic device capable of executing instructions. However, these are merely examples of a processor and claimed subject matter is not limited in these respects.

“Non-volatile storage” as referred to herein relates to one or more storage devices that are capable holding, storing and/or representing information when power is removed from the storage devices. Such storage devices of a non-volatile storage may include, for example and without limitation, flash memory devices, optical storage media and/or magnetic storage media. In one particular example, although claimed subject matter is not limited in this respect, a non-volatile storage may store data and/or machine-readable instructions while power is removed. However, these are merely examples of a non-volatile storage and claimed subject matter is not limited in this respect.

A computing platform may employ different types of information storage devices based, at least in part, on information storage capacity needs, access speed performance, cost, power consumption among other considerations. A “mass storage device” as referred to herein relates to one or more storage devices for storing large quantities of information. In one particular embodiment, although claimed subject matter is not limited in this respect, a computing platform may tolerate slower access speeds of a mass storage device than with other execution critical storage devices such as, for example, system memory and/or cache memory. In particular examples, a mass storage device may comprise one or more magnetic disks, magnetic tape, dense flash memory, compact disks and/or the like. However, these are merely examples of mass storage devices and claimed subject matter is not limited in these respects.

A “file storage device” as referred to herein relates to one or more storage devices that are capable of storing files in a retrievable format. In one particular example, although claimed subject matter is not limited in this respect, files stored on a file storage device may be associated with corresponding file names. Such files may be organized by file names in one or more file directories having, for example, a hierarchical data structure. In one particular embodiment, although claimed subject matter is not limited in this respect, a file storage device may comprise one or more mass storage devices for storing retrievable files. However, these are merely examples of how a file storage device may be implemented and claimed subject matter is not limited in this respect.

“Launch” as referred to herein relates to initiation of execution of a computer controlled process. In one particular example, although claimed subject matter is not limited in this respect, such a launch may comprise storing machine-readable instructions of a computer program in a storage medium, and initiating execution of the stored instructions by a processor and/or processing circuitry. Here, such a launching of a computer program may control one or more aspects of the behavior of a computing platform and/or computing device. However, these are merely examples of a launching of a computer controlled process and claimed subject matter is not limited in these respects.

A “media device” as referred to herein relates to a device that is capable of generating environmental stimuli such as, for example, sounds and/or images in response to encoded information. For example, a media device may be capable of reproducing video images, music and/or other audio signals based, at least in part, on data which is encoded according to a predetermined encoding format. In one embodiment, a media device may comprise an output device such as, for example, a display and/or speaker for generating environmental stimuli. Alternatively, a media device may not necessarily be comprise such an output device but instead may be capable of being coupled to such an output device to provide one or more signals to the output device for generating environmental stimuli. However, these are merely examples of a media device and claimed subject matter is not limited in these respects.

A “content signal” or “content data” as referred to herein relates to a signal and/or data comprising information that is representative of environmental stimuli such as sounds and/or visual images. Here, the terms “content signal” and “content data” shall be used interchangeably throughout. In one particular embodiment, for example, a content signal may comprise signals which are encoded according to a predetermined format. Here, for example, a content signal may comprise encoded signals that are representative of audio, video, text and/or still images. However, these are merely examples of a content signal and claimed subject matter is not limited in these respects.

According to an embodiment, a media device may be capable of providing a presentation in response to and/or based on, at least in part, a content signal. In a particular embodiment, for example, a media device may be capable of, by itself or in combination with one or more output devices, displaying images and/or generating sounds which are based, at least in part, on one or more content signals.

According to an embodiment, a content signal may comprise information that is temporally defined with reference to a presentation to an audience. In a particular embodiment, for example, a content signal comprising a video component may comprise sequential frames which are temporally referenced to portions of a video presentation. In another particular embodiment, a content signal comprising an audio component may comprise sequential segments that are temporally referenced to portions of an audio presentation. However, these are merely examples of how a content signal may comprise segments which are temporally referenced to portions of a presentation and claimed subject matter is not limited in these respects.

According to an embodiment, a content signal may be transmitted from a source to a destination by “streaming” the content signal whereby a first temporally referenced portion of the content signal is presented at a media device while a subsequent temporally referenced portion is being contemporaneously transmitted and/or delivered to the media device for subsequent presentation. In a particular embodiment, for example, a media device may display images, by itself or in combination with one or more output devices, of a leading portion of a streamed video signal while a trailing portion of the video signal is being transmitted and/or delivered to the media device. Similarly, a media device may generate sounds based, at least in part, on a leading portion of a streamed audio signal while a trailing portion of the audio signal is being transmitted and/or delivered to the media device. However, these are merely examples of how a content signal may be streamed to a media device and claimed subject matter is not limited in these respects.

A “communication adapter” as referred to herein relates to one or more devices capable of transmitting and/or receiving information from a communication channel and/or data link. In one particular embodiment, for example, a communication adapter may be capable of transmitting information to and/or receiving information from a data transmission medium according to a predefined communication protocol. However, this is merely an example of a communication adapter and claimed subject matter is not limited in this respect.

“Power” as referred to herein relates to a transfer of energy to a system and/or devices to enable the system and/or devices to operate in an intended fashion. Power may be provided to an electronic device and/or collection of devices from electrical energy as either a direct current or alternating current provided across power input terminals. However, these are merely examples of how power may be applied to enable operation of a device and claimed subject matter is not limited in this respect.

A “server” as referred to herein relates to one or more devices and/or one or more processes on a network that manage and/or control network resources. For example, a file server may comprise a computer and storage device for storing files. Accordingly, client users may store files on and/or retrieve files from the file server by accessing the network. Similarly, a server may store content data on one or more storage devices. Here, a client user may obtain the stored content data by accessing a network that communicates with the server. In other embodiments, a server may comprise one or more software controlled processes (e.g., through execution of machine-readable instructions) enabling the storage of files and/or content data for access as illustrated above. However, these are merely examples of a server and claimed subject matter is not limited in these respects.

A “data transmission network” as referred to herein relates to infrastructure that is capable of transmitting data among nodes which are coupled to the data transmission network. For example, a data transmission network may comprise links capable of transmitting data between nodes according to one or more data transmission protocols. Such links may comprise one or more types of transmission media capable of transmitting information from a source to a destination. However, these are merely examples of a data transmission network and claimed subject matter is not limited in these respects.

A data transmission network may transmit information between nodes in one or more “wireless links.” A wireless link may comprise a system to transmit information from a source node to a destination node without the use of cabling connecting the source node to the destination node. In one particular embodiment, for example, data may be transmitted in a wireless link in data packets and/or data frames according to a wireless communication protocol. In other embodiments, a wireless link may transmit information in radio frequency (RF) or infrared (IR) signals. However, these are merely examples of a wireless link and claimed subject matter is not limited in these respects.

According to an embodiment, processes associated with nodes of a data transmission network may be associated with “network addresses.” In one particular embodiment, although claimed subject matter is not limited in this respect, such a network address may be used in routing data packets to a process associated with the network address according to a communication protocol. Here, for example, such a network address may comprise an Internet Protocol (IP) address formatted according to the well known Internet Protocol.

A “client” as referred to herein relates to a process that is capable of receiving one or more services from a server to perform some application. In particular embodiments, although claimed subject matter is not limited in this respect, a client may be associated with a network address to enable communication between a server and the client according to a communication protocol. Such a client may be executed and/or hosted by a “client device” connected to a digital communication network. However, these are merely examples of how a client may be implemented and claimed subject matter is not limited in this respect.

A “media server” as referred to herein relates to a server that is capable of providing content data to one or more clients according to a communication protocol. In one particular example, although claimed subject matter is not limited in this respect, a media server may be capable of providing digitized content data in any one of several forms including, for example, streamed content data. However, this is merely an example of a media server and claimed subject matter is not limited in this respect.

Briefly, an embodiment relates to a system and/or method of hosting a media server that is capable of being automatically launched in response to application of power to a computing device and/or computing platform hosting the media server. In one particular embodiment, although claimed subject matter is not limited in this respect, machine-readable instructions for enabling the media server may be automatically retrieved from a non-volatile storage and executed by a processor in response to the application of power. Here, accordingly, following application of power to a device no additional user interaction is needed for enabling clients to access media files through the launched media server. However, this is merely an example embodiment and claimed subject matter is not limited in this respect.

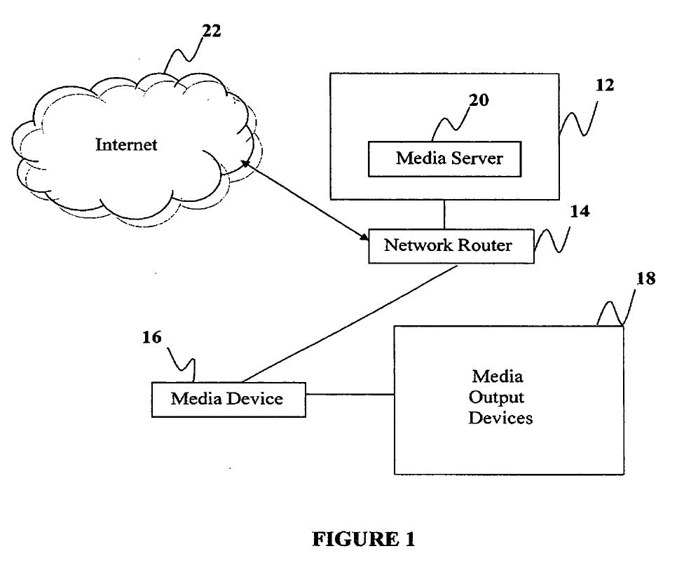

FIG. 1 is a schematic diagram of a network topology 10 according to an embodiment. A device 12 may be capable of hosting a media server 20 for providing content data to one or more client devices including, for example, a media device 16. Here, for example, media device 16 may comprise a media player that is capable transforming and/or transcoding content data received from media server 20 for presentation and/or rendering on one or more media output devices 18. Device 12 may store content data in memory that is capable of being presented and/or rendered on media output devices 18. Such content data may comprise, for example, digitally encoded versions of musical works, photographs, movies, electronic games, recorded radio and/or television broadcasts, on-line content (e.g., on-line radio and/or television broadcasts) and/or the like. However, these are merely examples of content data and claimed subject matter is not limited in this respects. Media output devices 18 may comprise one or more devices for generating environmental stimuli for presenting media based, at least in part, on signals from media device 16.

According to an embodiment, information may be transmitted between device 12 and client devices (e.g., media device 16) through network router 14 according to any one of several data communication protocols such as the aforementioned Internet Protocol. However, this is merely an example of a protocol that may be used to transmit information between devices in a network and claimed subject matter is not limited in this respect. In a particular embodiment illustrated in FIG. 1, device 12 may comprise a network adapter (not shown) to receive content data from one or more sources via an Internet 22 according to an Internet Protocol. Here, network router 14 may comprise, or be connected to, a set-top box and/or modem (not shown) to communicate with Internet 22. In other embodiments, device 12 may be connected directly to Internet 22 without an intervening network router. In other embodiments, server 20 may receive content data from other sources such as, for example, client devices coupled to network router 14. However, these are merely examples of how a server may obtain content data for delivery and/or distribution to a media device and claimed subject matter is not limited in these respects.

According to an embodiment, system 10 may be capable of integrating media server 20 and media device 16 as elements of a Universal Plug and Play Audio Visual (UPnP AV) architecture as illustrated in UPnP AV Architecture: 0.83 for UPnP Version 1.0, UPnP Forum, Jun. 12, 2002. Here, for example, media server 20 may comprise a substantially UPnP AV compliant MediaServer comprising one or more devices and/or software controlled processes capable of providing content data as discussed above from any one of several sources such as, for example, personal computers, VCRs, DVD players, video camcorder, mass storage devices, broadband receivers (e.g., for receiving satellite, cable and/or DSL transmissions), set-top boxes, DVRs and/or the like. However, these are merely examples of devices that may provide a server with content data for transmission to a media device and claimed subject matter is not limited in this respect. Media device 16 may comprise a substantially UPnP AV compliant MediaRenderer according to the aforementioned UPnP AV architecture.

According to an embodiment, media device 16 may comprise a UPnP Control Point that is capable of controlling one or more aspects of a presentation and/or rendering of media through media output devices 18 in response to a user control panel (not shown), for example. Alternatively, media device 16 may be responsive to a remote control (not shown) comprising such a UPnP Control Point for controlling one or more aspects of a presentation and/or rendering of media through media output devices 18. Such controllable aspects of a rendering and/or presentation of media may include, for example, volume, tone, brightness, contrast, stop, pause, seek and/or the like. However, these are merely examples of how a UPnP Control Point may affect a presentation and/or rendering of media through output devices and claimed subject matter is not limited in these respects.

Comprising a UPNP MediaServer and MediaRenderer, respectively, media server 20 and media device 16 may interact with one another through a UPnP discovery procedure known to those of ordinary skill in the art of UPnP systems. Here, for example, media server 20 and media device 16 may discover one another through a Simple Service Discovery Protocol (SSDP). Following such a discovery procedure, media server 20 may provide content data to media device 16 in messages according to a communication protocol such as, for example, a Hypertext Transfer Protocol (HTTP). In one particular embodiment, although claimed subject matter is not limited in this respect, media server 20 may stream image data to media device 16 for real-time presentation and/or rendering of media through media output devices 18.

In addition to providing a media server 20, device 12 may provide a network attached storage (NAS) device enabling storage and/or retrieval of data files in one or more file storage devices (not shown). In one particular embodiment, although claimed subject matter is not limited in this respect, such a NAS device may comprise a server may enable sharing of files among client devices through network router 14. Here, client devices may request storage and/or retrieval of data in files maintained by the NAS by transmitting one or more data packets to the NAS. However, this is merely an example of how a NAS may be implemented in a computing platform and/or computing device and claimed subject matter is not limited in this respect.

According to an embodiment, device 12 may comprise a stand alone appliance comprising an enclosure and/or sockets for wired data connections. Device 12 may receive power from a power source such as, for example, electricity from a utility wall socket and/or replaceable and/or rechargeable batteries. In a particular example, a power terminal (not shown) may provide a power signal to device 12 from an external power source. In one embodiment, such a terminal to receive power may comprise, for example, a socket to receive a power adapter that is pluggable into a utility wall socket, a power cord that is pluggable into a utility wall socket and/or a power cord combined with a power adapter to transmit a power signal to device 12 from a utility wall socket. In another embodiment, device 12 may also comprise a user accessible power on/off switch (not shown) enabling a user to selectively apply and/or remove power to device 12 from a power source.

As described below in connection with a particular embodiment, a user may automatically launch media server 20 by merely applying power to device 12 from a power source. Here, for example, such an application of power may comprise, for example, switching a power on/off switch to an “on” position and/or physically connecting device 12 to a power source (e.g., connecting device 12 to a utility wall socket). However, these are merely examples of how a user may apply power to a device from a power source and claimed subject matter is not limited in this respect. By automatically launching a media server in response to application of power from a power source, a user need not take additional action to launch a media server. In particular embodiments, although claimed subject matter is not limited in this respect, device 12 may establish wired and/or wireless connectivity with devices such as, for example, network router 14 in response to application of power to device 12 via a power on/off switch and/or physical connection of device 12 to a power source. Similarly, again according to particular embodiments, such wireless and/or wired connectivity may be disabled through subsequent removal of power to device 12 via a power on/off switch and/or disconnecting device 12 from a power source.

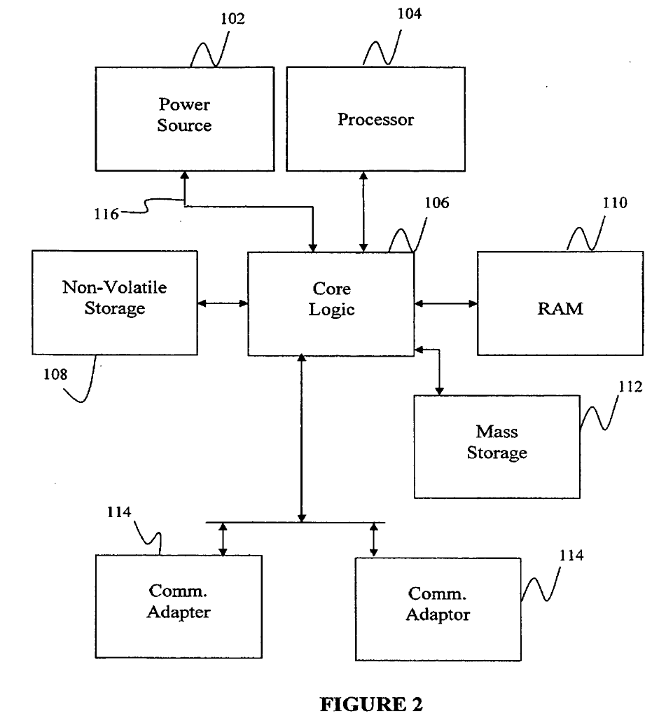

FIG. 2 is a schematic diagram of a device 100 capable of hosting a server according to an embodiment of device 12. A processor 104, random access memory (RAM) 110, non-volatile storage 108, mass storage 112 and communication adapters 114 may be communicatively coupled by core logic 106. According to a particular embodiment, core logic 106 may enable devices to communicate with one another over particular device interfaces. Additionally, core logic 106 may activate and/or set devices of device 100 in response to events and/or conditions. Core logic 106 may comprise logic and/or controllers formed on one or more semiconductor devices using techniques known to those of ordinary skill in the art.

Device 100 may comprise one or more communication adapters 114 capable of transmitting and/or receiving information through a wired or wireless communication link according to a data link protocol such as, for example, versions of IEEE Std. 802.3, IEEE Std. 802.11, Universal Serial Bus, Bluetooth, Firewire and/or the like. However, these are merely examples of a data link protocol that may be used for communicating over a data link and claimed subject matter is not limited in this respect. In a particular embodiment, a communication adapter 114 may employ direct memory access (DMA) techniques to store data received from a data link in buffer locations of RAM 110 and/or transmit data from such buffer locations through a data link. However, this is merely an example of how a communication adapter may transmit data between a data link and memory, and claimed subject matter is not limited in these respects.

Mass storage 112 may comprise one or more mass storage devices capable of storing retrievable information such as, for example, files, documents, content data (e.g., digital photographs, video data, audio data and/or the like). According to a particular embodiment, although claimed subject matter is not limited in this respect, mass storage 112 may comprise one or more file storage devices enabling processes executing on processor 104 to store information on and/or retrieve information from mass storage 12 according to a hierarchical directory structure.

According to an embodiment, device 100 may host an operating system and/or one or more applications from machine-readable instructions that are stored in RAM 110 and executed by processor 104. In one particular embodiment, although claimed subject matter is not limited in this respect, device 100 may host any one of several operating systems suitable for embedded applications such as, for example, versions of Linux available as open source, Windows CE from Microsoft Inc. and/or SuperTask from U.S. Software. Additionally, device 100 may host applications capable of accessing information on mass storage 112 in response to requests such as, for example, a media server, file transfer protocol (FTP) server, HTTP server, data back-up utility, e-mail server and/or the like. However, these are merely examples of applications that may be hosted on a device to access information on a mass storage and claimed subject matter is not limited in this respect. In a particular embodiment of a media server hosted on device 100, for example, such- a media server may response to requests from client processes received on a communication adapter 114 according to one more of the aforementioned data communication protocols.

According to a particular embodiment, although claimed subject matter is not limited in this respect, a media server hosted on device 100 may be associated with a network address, such as an IP address, to enable communication with client processes (e.g., hosted on media device 16) through a communication adapter according to a data communication protocol such as the aforementioned Internet Protocol. The hosted media server may receive requests from client process as data packets formatted with the IP address of the media server. Here, such a media server may respond to such requests by, for example, retrieving data from mass storage 112 and transmitting portions of the retrieved data in data packets through a communication adapter 114 to a requesting client process in data packets addressed to the requesting client process. In one particular embodiment, although claimed subject matter is not limited in this respect, such a media server may stream content data to a client process through a communication adapter 114 in response to such a request. In one particular embodiment, although claimed subject matter is not limited in this respect, device 100 may host a substantially UPnP AV compliant MediaServer. However, this merely an example of a server that may be hosted on a device and claimed subject matter is not limited in these respects.

According to an embodiment, non-volatile storage 108 may comprise any one of several types of non-volatile storage devices capable of storing machine-readable instructions such as, for example, flash memory. In response to an event, core logic 106 may retrieve machine-readable instructions from non-volatile storage 108 and load the retrieved instructions beginning at a predetermined address in RAM 110 for execution by processor 104. Processor 104 may then commence execution of the instructions at the predetermined address. It should be understood, however, that this is merely an example of how a computing device may respond to a reset event and claimed subject matter is not limited in this respect. In a particular embodiment, although claimed subject matter is not limited in this respect, such an event may comprise a reset event that may be initiated in response to a power up event. Here, for example, such a power up event may comprise an application of a power signal by power source 102 to a power bus 116 connecting power source 102 to core logic 106.

According to an embodiment, power source 102 may comprise power supply circuitry capable of generating one or more direct current (DC) power signals to enable operation of the other devices of device 100 as described above. Here, power source 102 may be connected to a utility plug (not shown) adapted to be connected to utility wall socket (e.g., 110V or 220V AC). Alternatively, power source 102 may comprise one or more replaceable and/or rechargeable batteries. In one particular embodiment, although claimed subject matter is not limited in this respect, power source 102 may apply power to power bus 116 in response to connecting the utility plug into a utility wall socket and remove power from power bus 116 in response to unplugging the utility plug. Alternatively, while power source 102 is connected to a utility wall socket by a utility plug, power source 102 may apply and remove power to power bus 116 in response to a user accessible on/off switch. It should be understood, however, that these are merely examples of how power may be applied to and/or removed from devices from a power source and claimed subject matter is not limited in this respect.

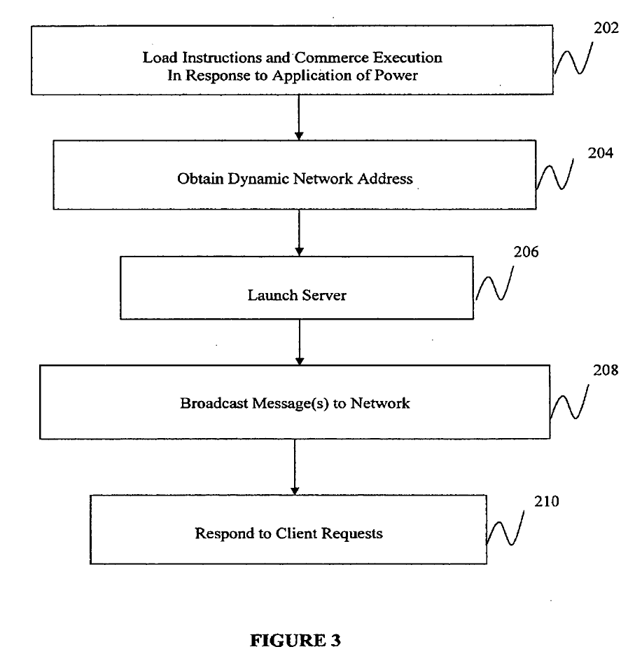

According to an embodiment, a media server may be launched on device 100 in response to a reset event without any intervening action by a user. Such a media server may be launched through execution of machine-readable instructions which are stored in non-volatile storage 108 in response to a reset event such as application of power to core logic 106 from power source 102. FIG. 3 is a flow diagram illustrating a process 200 to launch a server in response to a reset event, such as application of power to devices of a computing platform or computing device, according to an embodiment. In one particular embodiment, although claimed subject matter is not limited in this respect, process 200 may be executed in response to one of the aforementioned reset events in connection with device 100 discussed above.

According to a particular embodiment, although claimed subject matter is not limited in this respect, block 202 may comprise retrieving machine-readable instructions from a non-volatile storage and loading the retrieved instructions to a predetermined location in a memory which is addressable by a processor. The processor may then begin executing the stored instructions.

According to an embodiment, execution of machine-readable instructions at block 202 may comprise, for example, execution of one or more diagnostic routines, initialization of input/output devices a computing device and/or computing platform, and/or the like. Execution of machine-readable instructions at block 202 may also comprise launching of an operating system that is to control resources of a computing device and/or computing platform for executing application programs. However, these are merely examples of events which may occur in response to commencing execution of instructions in response to an application of power and claimed subject matter is not limited in these respects.

In response to execution of machine-readable instructions at block 202, block 204 may obtain a dynamic network address (e.g., an IP address) from a host such as an Internet service provider (ISP) (e.g., through Internet 22). In one particular embodiment, although claimed subject matter is not limited in this respect, a computing device and/or computing platform executing process 200 may comprise one or more communication adapters to transmit and or received data packets to a domain name host for receiving an IP address according to a Dynamic Host Configuration Protocol (DHCP). In an alternative embodiment, however, a network address may be statically allocated. Nevertheless, these are merely examples of how a device may obtain a network address to enable communication with processes on a data communication network according to a communication protocol and claimed subject matter is not limited in this respect.

Instructions retrieved from a non-volatile storage and loaded to a processor accessible memory at block 202 may also comprise machine-readable instructions to launch a server. In alternative embodiments, these machine-readable instructions may also launch a file server enabling a platform to have functionality of the aforementioned NAS device. Block 206 may commence execution of such instructions to launch a media server and/or file server without any intervening action by an operator. In one particular embodiment, although claimed subject matter is not limited in this respect, such a media server and/or file server may be automatically launched following launching of an operating system at block 206. However, this is merely an example of how a server may be automatically launched in response to application of power and claimed subject matter is not limited in this respect.

Block 208 may broadcast messages containing information descriptive of the one or more servers launched at block 206 to other devices on a data transmission network such as, for example, media device 16 (FIG. 1). Such information may include, for example, metadata descriptive of one or more functions of a launched server, an identifier associated with the launched server and/or the network address obtained at block 206. In one particular embodiment, although claimed subject matter is not limited in this respect, block 208 may “advertise” the existence of the launched media server using the aforementioned SSDP protocol by broadcasting one or more messages containing an obtained network address, a type identifier and a pointer to additional information to other processes on a data transmission network. However, this is merely one example of how a launched media server may broadcast information to other processes on a data transmission network and claimed subject matter is not limited in this respect.

According to an embodiment, processes on a data transmission network may request services of the launched media server using information broadcasted at block 208. In one particular example, although claimed subject matter is not limited in this respect, Control Points on a data transmission network defined according a UPnP AV architecture may receive the broadcasted messages from the media server and request one or more services of the media server by transmitting requests to the media server based, at least in part, on information in messages broadcasted at block 208. Such services may include, for example, access and retrieval of stored media files, streaming of content, and/or the like. However, these are merely examples of services that may be requested of a media server and claimed subject matter is not limited in these respects. The launched media server may then respond to such requests as, for example, a substantially UPNP AV compliant MediaServer as illustrated above.

While there has been illustrated and described what are presently considered to be example embodiments, it will be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular embodiments disclosed, but that such claimed subject matter may also include all embodiments falling within the scope of the appended claims, and equivalents thereof.

1. An apparatus:
one or more communication adapters capable of transmitting information to and/or receiving information from a data transmission network;
one or more mass data storage devices capable of storing content data;
a non-volatile storage;
a processor to execute machine-readable instructions stored on said non-volatile storage for automatically launching a media server in response to application of power to said device from a power source, said media server being capable of transmitting content data to one or more client devices through said one or more communication adapters.

2. The apparatus of claim 1, wherein said application of power to said media device comprises connecting said device to a utility outlet.

3. The apparatus of claim 1, wherein said application of power to said media device comprises positioning of a user selectable switch.

4. The apparatus of claim 1, wherein said launching said media server further comprises obtaining an Internet Protocol address via said one or more communication adapters according to a Dynamic Host Configuration Protocol in response to said application of power.

5. The apparatus of claim 4, wherein said launching said media server further comprises broadcasting said Internet Protocol address to devices on said data transmission network through said one or more communication adapters according to an SSDP protocol.

6. The apparatus of claim 1, wherein said media server is further capable of streaming media to client devices via said one or more communication adapters according to an HTTP protocol.

7. The apparatus of claim 1, wherein said apparatus further comprises a router coupled to said one or more communication adapters.

8. The apparatus of claim 1, wherein said launched media server comprises a substantially UPnP AV compliant MediaServer.

9. The apparatus of claim 1, wherein said media server is capable of streaming content data stored on said one or more mass storage devices to one of said client devices via said one or more communication adapters for presentation at a media device associated with said client.

10. The apparatus of claim 1, wherein said apparatus further comprises logic initiate execution of instructions by said processor to launch a file server in response to said application of power.

11. A method comprising:
applying power to a device from a power source, said device comprising one or more communication adapters capable of transmitting information to and/or receiving information from a data transmission network; and
automatically launching a media server in response to said application of power to said device, said media server being capable of initiating transmission of content data stored on one or more mass storage devices to one or more client devices through said one or more communication adapters.

12. The method of claim 11, and further comprising automatically launching a file server in response to said application of power to said device.

13. The method of claim 11, wherein said applying power to a device from a power source further comprises connecting said device to a utility outlet.

14. The method of claim 11, wherein said applying power to a device from a power source further comprises positioning a user accessible switch.

15. The method of claim 11, and further comprising obtaining an Internet Protocol address according to a Dynamic Host Configuration Protocol in response to said launching.

16. The method of claim 15, and further comprising broadcasting said Internet Protocol address to devices on said data transmission network according to an SSDP protocol.

17. An article comprising:
a storage medium comprising machine-readable instructions stored thereon to:
automatically launch a media server to a computing platform in response to application of power to said computing platform from a power source.

18. The article of claim 17, wherein said storage medium further comprises machine-readable instructions stored thereon to obtain a dynamic IP address.

19. The article of claim 18, wherein said storage medium further comprises machine-readable instructions stored thereon to broadcast said dynamic IP address to devices connected to a data transmission network.

20. The article of claim 17, wherein said storage medium further comprises machine-readable instructions stored thereon to stream content data stored on one or more mass storage devices to one or more client devices.

21. A system comprising:
a computing platform comprising one or more mass data storage devices capable of storing content data and logic to launch a media server in response to application of power to said computing platform from a power source, said media server being capable of transmitting content data to one or more client devices through one or more communication adapters;
a media device to process content data received from said computing platform; and
one or more media output devices coupled to said media device capable of rendering media based, at least in part, on processed content data received from said media device.

22. The system of claim 21, and further comprising a network router to forward data packets between said media device and said computing device according to an Internet Protocol.

23. The system of claim 22, wherein said media device and said computing platform are coupled to said network router wireless data links.

24. The system of claim 22, wherein said network router is adapted to forward data packets between an Internet service provider and said computing platform according to said Internet Protocol.

25. The system of claim 21, wherein said media server is capable of streaming content data to said media device in response to a request from the media device.

26. The system of claim 21, wherein said media server comprises a substantial UPnP AV compliant MediaServer and said media device comprises a substantially UPnP AV compliant MediaRenderer.
